(19) United States
(12) Patent Application Publication
(10) Pub. No.: US 2024/0273149 A1
(43) Pub. Date: Aug. 15, 2024

(54) SYSTEMS AND METHODS TO IDENTIFY PSYCHOLOGICAL PROFILES OF USERS BY UTILIZING CORRELATIONS BETWEEN CONTENT CLASSIFICATIONS

(71) Applicant: Solsten, Inc., St. Paul, MN (US)

(72) Inventors: Joseph Jack Schaeppi, Maple Grove, MN (US); Jonna Maarit Koivisto, Berlin (DE)

(21) Appl. No.: 18/168,869

(22) Filed: Feb. 14, 2023

(51) Int. Cl. G06F 16/9535; G06F 16/28; G06F 16/9538

(52) U.S. Cl. CPC G06F 16/9535; G06F 16/285; G06F 16/9538

(57) ABSTRACT

Systems and methods to identify psychological profiles of users utilizing correlations between content classifications and content interaction are disclosed. Exemplary implementations may: obtain interaction information, from online platforms that provide the digital environments, for unprofiled users, the interaction information for individual unprofiled users specifying i) instances of interactions between the individual unprofiled users and one or more of the individual pieces of content via the digital environments and ii) timing information for the instances; convert the unprofiled users to profiled users, converting a first unprofiled user to a first profiled user including: inferring, based on the interaction information for the first unprofiled user and content-specific correlations stored in electronic storage, psychological parameter values of the first unprofiled user for one or more of the psychological parameters, and storing the inferred one or more psychological parameter values to a first psychological profile that characterizes the psychology of the first profiled user.

### FIELD OF THE DISCLOSURE

The present disclosure relates to systems and methods to identify psychological profiles of users to provide an adaptable digital environment.

### BACKGROUND

Existing systems may adapt digital environments for users based on how the users interact with content presented via the digital environments. These existing systems may fail to consider psychological profiles of the users. Furthermore, some of the users may lack an established psychological profile.

### SUMMARY

One aspect of the present disclosure relates to a system configured to identify psychological profiles of users by utilizing correlations between content classifications and content interaction. Some of the users of digital environments may not be associated with psychological profiles that characterize psychology of the individual users or the psychology of a user type. Such lack of association with psychological profiles may be due to being a new user of the digital environments, newly opting into establishment of psychological profiles, among others. In response, psychological profiles may be determined and established based on at least interactions of the users with various content provided by the digital environments and previously established correlations between pieces of content and psychological parameter values. Based on the psychological profiles, the digital environments may be regenerated or otherwise adjusted for the individual users. Thus, the system's utilization of unique information may cause generation of improved digital environments for the users. The system may include electronic storage, server(s) configured by machine-readable instructions, and/or other components.

The electronic storage may store i) taxonomical classifications, of individual pieces of content, ii) psychological profiles for profiled users of digital environments, iii) content-specific correlations. Individual taxonomical classifications may include content classes and content subclasses to the content classes for the individual pieces of content. the taxonomical classifications may conform to a taxonomy that defines a hierarchical system of the content classes and the content subclasses. The individual pieces of content may be designated by the corresponding taxonomical classifications as being included in specified ones of the content classes and the content subclasses. The psychological profiles may include psychological parameter values for psychological parameters that characterize psychology of individual profiled users. The content-specific correlations may be between the psychological parameter values of one or more of the psychological parameters included in the psychological profiles for the profiled users and the individual pieces of content.

The machine-readable instructions may include one or more instruction components. The instruction components may include computer program components. The instruction components may include one or more of information obtaining component, user converting component, content identifying component, presentation component, and/or other instruction components.

The information obtaining component may be configured to obtain interaction information, from online platforms that provide the digital environments, for unprofiled users. The interaction information for individual unprofiled users may specify i) instances of interactions between the individual unprofiled users and one or more of the individual pieces of content via the digital environments, ii) timing information for the instances, and/or other information.

The user converting component may be configured to convert the unprofiled users to profiled users. Converting a first unprofiled user to a first profiled user may include inferring, based on the interaction information for the first unprofiled user and the content-specific correlations, psychological parameter values of the first unprofiled user for one or more of the psychological parameters. Converting a first unprofiled user to a first profiled user may also include storing the inferred one or more psychological parameter values to a first psychological profile that characterizes the psychology of the first profiled user.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to identify psychological profiles of users by utilizing correlations between content classifications and content interaction, in accordance with one or more implementations.

FIG. 2 illustrates a method to identify psychological profiles of users by utilizing correlations between content classifications and content interaction, in accordance with one or more implementations.

FIG. 3A-B Illustrates an example implementation of the system configured to identify psychological profiles of users by utilizing correlations between content classifications and content interaction, in accordance with one or more implementations.

### DETAILED DESCRIPTION

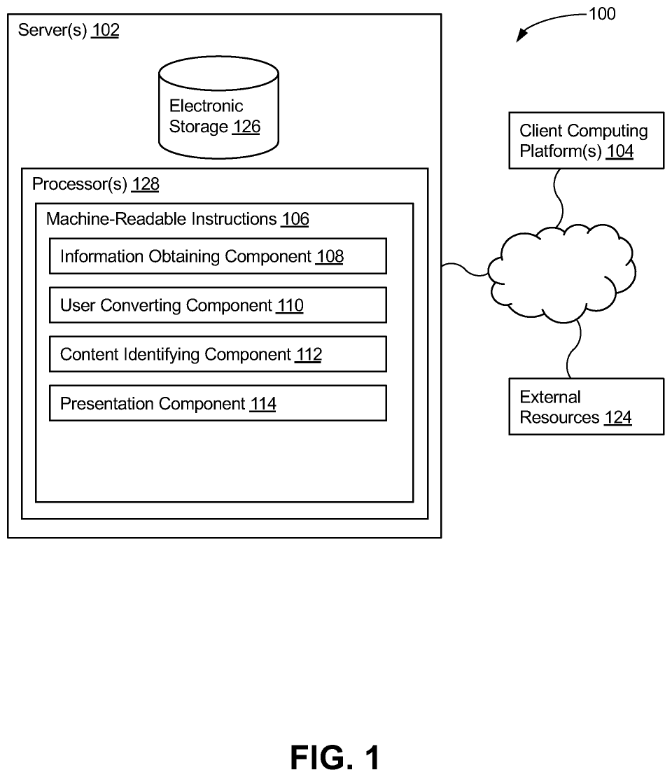

FIG. 1 illustrates a system 100 configured to identify psychological profiles of users by utilizing correlations between content classifications and content interaction, in accordance with one or more implementations. In some implementations, system 100 may include one or more servers 102, electronic storage 126, and/or other elements. Server(s) 102 may be configured to communicate with one or more client computing platform(s) 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Electronic storage 126 may store taxonomical classifications of individual pieces of content, psychological profiles for users of digital environments, content-specific correlations between psychological parameter values and individual pieces of content, and/or other information. Individual taxonomical classifications may include content classes and content subclasses to the content classes for the individual pieces of content. The taxonomical classifications may conform to a taxonomy that defines a hierarchical system of the content classes and the content subclasses. Individual pieces of content may be designated by the corresponding taxonomical classifications as being included in specified ones of the content classes and the content subclasses.

The pieces of content may include a portion of a character, a game, a game asset, video content, image content, sound or music content, and/or other pieces of content. The character may refer to an object (or group of objects) present in a virtual space that corresponds to an individual user (e.g., an avatar) and/or are controlled by the user. In some implementations, the character may not correspond to an individual user but rather provide information (e.g., the recommendation, the suggestion) to the user. The game asset may include a virtual item, a virtual resource (e.g., weapon, tool), of in-game powers, in-game skills, in-game technologies, and/or other game assets.

The digital environments may be hosted by or otherwise provided by online platforms. In some implementations, the digital environments may be accessible via applications. The applications may include mobile applications accessible via portable client computing platforms 104, desktop applications, console applications, television applications, and/or other applications. In some implementations, the online platforms may be directly accessed via web browsers and Internet, or offline. For example, the digital environments, and types thereof, may include, by way of non-limiting example, game environments, educational environments, reading environments, music interfaces, social networking environments, entertainment environments, fitness environments, business environments, shopping environments, food & drink providing environments, among others integrated or connected with system 100.

The digital environment and/or individual applications may provide simulated spaces or views of a virtual space. Individual simulated spaces may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial section of the space. In some instances, the topography may describe a volume with one or more bodies positioned therein (e.g., a simulation of gravity-deprived space with one or more celestial bodies positioned therein). The instance executed by the computer components may be synchronous, asynchronous, and/or semi-synchronous.

Some of the content classes may be high order classes and some of the content classes may be lower order subclasses. That is, a high order class may include more specific lower order subclasses where classification into the subclasses more specifically describe the content as further content subclasses exist for the lower order subclasses. In some implementations, a given (sub)class may be one or more hierarchical orders within the taxonomy. The content classes may include genre, platform-specific genre, mechanics, theme, art style and perspective, brand intellectual property, modes, churn, marketing assets, creative elements, and/or other content classes and subclasses. These content classes may be the highest order of classes of the content classes and subclasses. By way of non-limiting example, each of these content classes may include one or more lower order content subclasses.

A given genre may refer to a particular style, form, or set of content elements (e.g., action, adventure, sports, casino). A given platform-specific genre may a genre specific to a platform and/or real or virtual setting (e.g., arcade, music, party, racing, slots). A given mechanic may govern rules for the users and responses to actions by the users and/or actions of other pieces of content within the digital environment (e.g., physics). A given theme may refer to a particular subject or topic that the digital environment is related and developed around (e.g., crime/mystery, horror, vehicles). A given art style and perspective may refer to visual style, render technique, perspective, and/or other art styles and/or perspectives. A given brand intellectual property may refer to tangible or intangible concepts that may be afflicted with a brand (e.g., sports, game show, kids toy). A given mode may refer to a configuration of a digital environment and a role or position of the user/player within the digital environment (e.g., player-as-manager, single player, player-as-actor). A given churn may refer to how the users and/or content within the digital environment move in and out of the digital environment (e.g., deliberate). A given marketing asset may refer to an element that may facilitate promotion or presentation of a piece of content (e.g., placements, emotional drivers). A given creative element may refer to an artistic element that facilitate promotion of a piece of content (e.g., coin, flag, light bulb). The content classes and subclasses may be associated with a binary number, a yes or no, and/or other type of value.

In some aspects, the psychological profiles may include psychological profiles for profiled users of digital environments. A profiled user may include a user that has previously visited a website, played a game, watched a video, or otherwise interacted with a portion of content and has been associated with one or more psychological parameter values as a result of the interactions, stated information, and/or other information. In some aspects, the psychological profiles may include psychological parameter values for psychological parameters that characterize psychology of individual profiled users. In some aspects, the psychological profiles for users may include the stated information provided the user. For example, the stated information may include answers provided by the users to questions presented to the users, self-descriptions, characteristics, liked content, disliked content, content previously interacted with (e.g., watched, played, listened to, completed, visited), and/or other stated information.

In some implementations, a given psychological profile may characterize and be for a single unique user. In some implementations, the given psychological profile may characterize and be for more than one user, for example a group of alike users. A given psychological profile that characterizes more than one alike user may be particular for users that have similar or identical psychological parameter values. The psychological profiles may include the psychological parameter values to the psychological parameters. The psychological profiles may include sets of psychological parameter values to the psychological parameters for the individual users. By way of non-limiting example, the psychological parameter values of the psychological parameters may be a number score on a predetermined range unique to each psychological parameter, a letter score, and/or other type of value than may characterize a particular user as whole.

Parameters, such as psychological parameters described herein, may specify measurable, recordable, and/or determined information. The parameter values corresponding to the parameters may be a particular value, numerical or non-numerical, that characterizes the content, the users, or respective element that the parameter value is described in relation to. The psychological parameter values may characterize a given users feelings, emotions, perceptions, thoughts, and behaviors. By way of non-limiting example, the psychological parameters values may characterize competitiveness, goal orientation, and learning style, among others.

In some aspects, the content-specific correlations include known or profiled psychological parameter values or psychological profiles. The content-specific correlations may be between i) one or more of the psychological parameter values included in the psychological profiles of individual profiled users or the individual psychological profiles of the individual profiled users, and ii) the individual pieces of content.

In some implementations, a content-specific correlation may be between a single psychological parameter value to a psychological parameter or a set of psychological parameter values to a set of the psychological parameters, and an individual piece of content. In some implementations, a content-specific correlation may be between a psychological profile and an individual piece of content. Meaning, the set of psychological parameters and their psychological parameter values that comprise the entire psychological profile may be correlated with the individual piece of content.

It will be appreciated that the description herein of “correlations” between the one or more psychological parameter values or the individual psychological profiles, and a piece of content which are positively correlated is not intended to be limiting, and that negative correlations between the one or more psychological parameter values or the individual psychological profiles, and the piece of content are also contemplated, and may be included in the generic “correlations”. The determination of negative correlations may be made in cases where users strongly presenting a psychological parameter avoid a specific piece of content, and/or where users that do not present the psychological parameter interact with the specific piece of content relatively more (e.g., in frequency, total performances, etc.) than other users that strongly present the psychological parameter.

Server(s) 102 may be configured by machine-readable instructions 106. Machine-readable instructions 106 may include one or more instruction components. The instruction components may include computer program components. The instruction components may include one or more of information obtaining component 108, user converting component 110, content identifying component 112, presentation component 114, and/or other instruction components.

Information obtaining component 108 may be configured to obtain interaction information from the online platforms that provide the digital environments. The interaction information may characterize interactions between individual profiled or unprofiled users and the pieces of content via the digital environments, engagement by the users with the pieces of content, and/or other interaction information.

In some aspects, a determination may be made as to whether the interaction information is associated with a profiled user or an unprofiled user. The determination may be made using one or more identifiers, for example a username, an IP address, an account, a physical address, historical information, and/or other identifier. An unprofiled user may include any user that has not been assigned a psychological profile or one or more psychological parameter values to one or more psychological parameters. A profiled user may already be associated with or assigned a psychological profile or one or more psychological parameter values to one or more psychological parameters.

To determine or identify a psychological profile of unprofiled users, the system 100 first obtains the individual interaction information for the unprofiled users. The individual interaction information may specify i) instances of interactions between individual unprofiled users and one or more pieces of content via the digital environments, ii) timing information for the instances, and/or other information. In some implementations, the interaction information may be obtained in an ongoing manner from multiple online platforms for multiple users at once. The term “ongoing manner” as used herein may refer to continuing to perform an action (e.g., obtain) periodically (e.g., every 30 seconds, every minute, every hour, etc.) until receipt of an indication to terminate. The indication to terminate may include powering off system 100, shutting down the online platforms, resetting system 100, and/or other indications of termination. Thus, the instances of interactions may be collected, obtained, received, monitored, and/or analyzed.

The instances of interactions may include the content engaged with by the unprofiled users, how the individual unprofiled users engaged with the content, content not engaged with or avoided by the unprofiled users, and/or other interaction information. In some implementations, the interaction information may identify the unprofiled users. The content engaged with by the individual unprofiled users may be related to the digital environments or the individual online platforms that provide the content. That is, for example, the content provided by the digital environment may relate to online games (e.g., virtual goods, virtual mini games, etc.) the digital environment hosts. In some implementations, the content engaged with by the individual unprofiled users may not be related to the digital environments that provide the content. Meaning, the content may direct the user to a different digital environment

How the unprofiled users engage with the content, or engagement by the individual unprofiled users, may define behavior patterns of the individual users with or based on the content. The behavior patterns may include consecutive actions of the unprofiled users within the digital environments, with other ones of the users within the digital environments, with content within the digital environments, and/or other behavior patterns. The behavior patterns may indicate spending patterns of the users, completed tasks by the individual users, uncompletion tasks by the individual users, failure of tasks by the individual users, game mechanics initiated by the users, and/or other behavior patterns. The actions may include one or more of a purchase based on the content, a sale, a trade, a donation, a user selection of the content, gameplay (e.g., mini-game, battle, competition, etc.) based on the content, communication of the individual users with other particular users or users, completion of tasks by the users, frequent interaction with the content, formation of alliances by the users, and/or other actions. The spending patterns may indicate an amount of currency (e.g., real-world money, virtual money, points, etc.) spend, an amount of currency earned, an amount of currency donated, and/or other indications.

The game mechanics may include alternating turns in the one or more games, action points, playing cards, capturing, catch-up progression, dice, movements, resource management, risk and reward, role-playing, game modes (e.g., single-player, multiplayer), and/or other novel or known game mechanics. In some implementations, different ones of the games and/or the content provided by the online platforms via the digital environments may employ different game mechanics. Thus, the unprofiled user may initiate and utilize different game mechanics within the digital environments. Conversely, the user may disregard some of the game mechanics by disregarding some of the games and/or the content within the digital environments.

The timing information may include time spent by the individual unprofiled users engaging/interacting with the content, other users, and/or within the digital environment, frequency of subsequent re-interaction or initiation of subsequent instances, a time of day of the instances, a time of week of the instances, a time of year of the instances, special occasions during or near the instances (e.g., user's birthday, federal holidays), and/or other timing information

In some implementations, the interaction information may include the taxonomical classifications of the pieces of content that the unprofiled users have engaged and interacted with. In some implementations, the interaction information may identify the pieces of content that the unprofiled users have engaged and interacted with and information obtaining component 108 may be configured to determine the taxonomical classifications of such pieces of content. In some implementations, such taxonomical classifications may be stored in electronic storage 126 and retrieved. In some implementations, information obtaining component 108 may be configured to analyze the pieces of content based on the taxonomy to determine the taxonomical classifications. In some implementations, the taxonomical classifications may be obtained from the online platforms that host the digital environments.

By way of non-limiting example, information obtaining component 108 may be configured to obtain first interaction information that specifies at least a first instance of an interaction between a first unprofiled user and a first piece of content via the digital environments, timing information for the first instance, and/or other information. In some aspects, the first piece of content may be classified with a first content class and a first content subclass of a second content class.

In some implementations, user converting component 110 may be configured to determine whether a given user a profiled user or an unprofiled user. Responsive to determining that the given user is an unprofiled user, user converting component 110 may be configured to convert the unprofiled user to the profiled user. By way of non-limiting example, converting the unprofiled user to the profiled user may include converting a first unprofiled user to a first profiled user. User converting component 110 may infer, based on the interaction information for the first unprofiled user, the content-specific correlations, and/or other information, psychological parameter values of the first unprofiled user for one or more of the psychological parameters.

Inferring the psychological parameter values may include analyzing interaction information associated with the profiled users and/or other information, stored in electronic storage 126 or otherwise accessible by user converting component 110, that characterize interactions of the profiled users with one or more pieces of content. The analysis may determine one or more different interaction information that include or indicate the same taxonomical classifications as the pieces of content that the individual unprofiled users interacted with (as characterized by their respective interaction information). The one or more interaction information determined from the analysis may facilitate determination of the content-specific correlations to utilize.

In some implementations, the analysis may determine one or more different interaction information that include or indicate pieces of content with similar taxonomical classifications as the pieces of content that the individual unprofiled users interacted with (as indicated by their respective interaction information). For example, all the pieces of content interacted with by the profiled users and the unprofiled users may not be exactly the same, but a majority the same, or may not be exactly the same taxonomical classifications but a majority the same. In some implementations, the analysis may determine one or more different interaction information that include pieces of content with similar or identical taxonomical classifications as the pieces of content that the individual unprofiled users interacted with, similar interactions (i.e., how the profiled users and unprofiled users engaged with the pieces of content), similar timing information of the interactions, and/or other similar information. For example, the similar interaction may be that a particular piece of content was purchased and customized subsequent to creation of a new character. That is, based on the pieces of content that the unprofiled and the profiled users engage with, how they engage, and the timing information of the instances of interactions, the content-specific correlations may be determined for profiled users. The various interaction information may indicate similar timing information, similar behavior patterns, pieces of content with a common content class/subclass, pieces of content with a majority similar taxonomical classifications, pieces of content with identical taxonomical classifications, and/or other similarities that provide a basis to the content-specific correlations.

Based on the one or more interaction information determined, particular the content-specific correlations may be identified. The content-specific correlations may be predetermined or known by system 100 and utilized by user converting component 110 to infer the psychological parameter values to the psychological parameters for unprofiled users. Given the content-specific correlations and the particular pieces of content determined, a set of one or more psychological parameter values from the psychological profiles of the determined profiled users may be identified. Thus, the identified set may be the inferred psychological parameter values for the unprofiled users, e.g., the first unprofiled user.

User converting component 110 may be configured to store the inferred one or more psychological parameter values to a first psychological profile that characterizes the psychology of the first profiled user. In some implementations, user converting component 110 may be configured to store the inferred one or more psychological parameter values in electronic storage 126.

In some implementations, responsive to determination that the given user is a profiled user, content identifying component 112 may be configured to identify prospective pieces of content for the profiled users based on the psychological parameter values inferred by user converting component 110 and stored to respective psychological profiles. The prospective pieces of content may be one or more of the pieces of content that may be presented to the profiled users via the digital environment because they deemed to be appropriate for the profiled user based on their inferred psychological parameter values, established psychological parameter values based on the stated information, and/or other information. The pieces of content may be presented to the users or made discoverable by the profiled users within the digital environments. The prospective pieces of content may be identified by content identifying component 112 based on an affinity of a psychological profile or one or more psychological parameter value to the prospective pieces of content. In some aspects, content having a specific taxonomy classification class or subclass may be presented to the profiled user.

Presentation component 114 may be configured to effectuate presentation of the prospective pieces of content to the profiled users within the digital environments. In some implementations, the presentation of the prospective pieces of content may include presenting the prospective content integrated into the digital environments. That is, for example, given that the digital environment is a simulation game, the prospective pieces of content may be presented or discoverable where appropriate within the simulation game. Appropriateness of presentation of discoverability of the prospective pieces of content may be based on the active pieces of content, progress of the profiled user within the digital environment, a virtual location of the profiled user or a character of the user within the digital environment, a time of day within the digital environment, and/or other information.

In some implementations, the presentation of the prospective pieces of content may include presenting a list of the prospective pieces of content within the digital environments. As such, the profiled users may select which prospective pieces of content from the list to integrate into the digital environment, interact with at time of selection, remove from the list, and/or other actions related to presentation. The selection to integrate one or more of the prospective pieces of content from the list into the digital environment may cause such pieces to be presented or discoverable where appropriate within the digital environment.

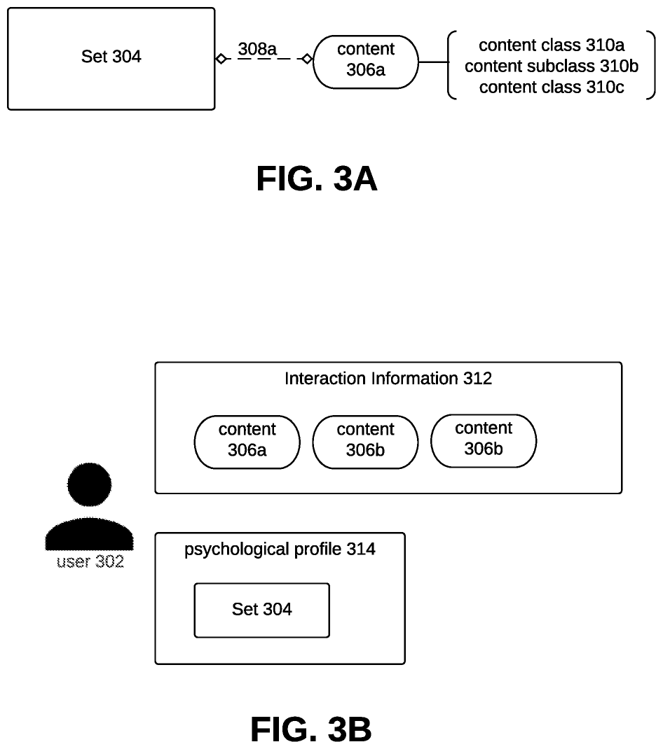

FIG. 3A illustrates a content-specific correlation stored in electronic storage 126 and utilized to infer psychological parameter values to psychological parameters for unprofiled users. A set 304 of one or more psychological parameter values (to the same psychological parameter). Set 304 may be correlated with content 306a (e.g., wearable armor) based on interaction information obtained (illustrated in FIG. 3B), e.g., users with set 304 in their psychological profile frequently collect, purchase, or create their own wearable armor. Thus, content-specific correlations 308a may be established. Content 306a may be classified into content class 310a (e.g., protection), content subclass 310b (e.g., wearable), and content class 310c (e.g., battles).

FIG. 3B illustrates interaction information 312 for a user 302 that is initially unprofiled. That is, user 302 may not be associated with an established psychological profiles that includes psychological parameter values to psychological parameters. Interaction information 312 may include content 306a, 306b, and 306c that user 302 has interacted with within digital environments. Based on content-specific correlation 308a illustrated in FIG. 3A, among others not illustrated, and based on interaction information 312, a psychological profile 314 may be inferred for user 302. Psychological profile 314 may include at least set 304 of psychological parameter values. Thus, user 302 that had been previously unprofiled may be converted to a profile user.

In some implementations, server(s) 102, client computing platform(s) 104, and/or external resources 124 may be operatively linked via one or more electronic communication links. For example, such electronic communication links may be established, at least in part, via a network such as the Internet and/or other wired or wireless networks. It will be appreciated that this is not intended to be limiting, and that the scope of this disclosure includes implementations in which server(s) 102, client computing platform(s) 104, and/or external resources 124 may be operatively linked via some other communication media.

A given client computing platform 104 may include one or more processors configured to execute computer program components. The computer program components may be configured to enable an expert or user associated with the given client computing platform 104 to interface with system 100 and/or external resources 124, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 124 may include sources of information outside of system 100, external entities participating with system 100, and/or other resources. In some implementations, some or all of the functionality attributed herein to external resources 124 may be provided by resources included in system 100.

Server(s) 102 may include electronic storage 126, one or more processors 128, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 126 may comprise non-transitory storage media that electronically stores information. The electronic storage media of electronic storage 126 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 126 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 126 may include one or more virtual storage resources (e.g., cloud storage, a virtual private network, and/or other virtual storage resources). Electronic storage 126 may store software algorithms, information determined by processor(s) 128, information received from server(s) 102, information received from client computing platform(s) 104, and/or other information that enables server(s) 102 to function as described herein. User converting component 110 may utilize electronic storge 126 for storing information.

Processor(s) 128 may be configured to provide information processing capabilities in server(s) 102. As such, processor(s) 128 may include one or more of a digital processor, an analog processor, a digital circuit designed to process information, an analog circuit designed to process information, a state machine, and/or other mechanisms for electronically processing information. Although processor(s) 128 is shown in FIG. 1 as a single entity, this is for illustrative purposes only. In some implementations, processor(s) 128 may include a plurality of processing units. These processing units may be physically located within the same device, or processor(s) 128 may represent processing functionality of a plurality of devices operating in coordination. Processor(s) 128 may be configured to execute components 108, 110, 112, and/or 114, and/or other components. Processor(s) 128 may be configured to execute components 108, 110, 112, and/or 114, and/or other components by software; hardware; firmware; some combination of software, hardware, and/or firmware; and/or other mechanisms for configuring processing capabilities on processor(s) 128. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, and/or 114 are illustrated in FIG. 1 as being implemented within a single processing unit, in implementations in which processor(s) 128 includes multiple processing units, one or more of components 108, 110, 112, and/or 114 may be implemented remotely from the other components. The description of the functionality provided by the different components 108, 110, 112, and/or 114 described below is for illustrative purposes, and is not intended to be limiting, as any of components 108, 110, 112, and/or 114 may provide more or less functionality than is described. For example, one or more of components 108, 110, 112, and/or 114 may be eliminated, and some or all of its functionality may be provided by other ones of components 108, 110, 112, and/or 114. As another example, processor(s) 128 may be configured to execute one or more additional components that may perform some or all of the functionality attributed below to one of components 108, 110, 112, and/or 114.

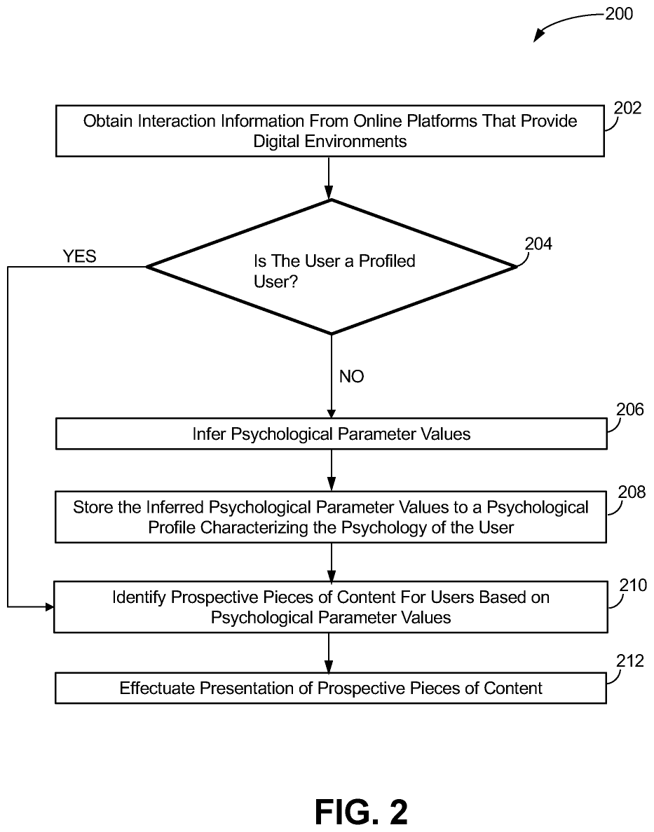

FIG. 2 illustrates a method 200 to identify psychological profiles of users utilizing correlations between content classifications and content interaction, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining interaction information from online platforms that provide the digital environments. Individual interaction information may specify instances of interactions between individual users and one or more pieces of content via the digital environments and timing information for the instances. Taxonomical classifications of the individual pieces of content and the psychological profiles for profiled users of digital environments may be stored in electronic storage. Individual taxonomical classifications may include content classes and content subclasses to the content classes for the individual pieces of content. The taxonomical classifications may conform to a taxonomy that defines a hierarchical system of the content classes and the content subclasses. The pieces of content may be characterized by the classifications into the content classes and the content subclasses. The psychological profiles may include psychological parameter values for psychological parameters and be associated with one or more profiled user. Operation 202 may be performed by one or more hardware processors configured by machine-readable instructions including a component that is the same as or similar to information obtaining component 108, in accordance with one or more implementations.

An operation 204 may include determining if a user is a profiled user or an unprofiled user. Operation 204 may be performed by one or more hardware processors configured by machine-readable instructions including a component that is the same as or similar to user converting component 110, in accordance with one or more implementations.

An operation 206 may include inferring, based on the interaction information for a first unprofiled user and any content-specific correlations, psychological parameter values of the first unprofiled user for one or more of the psychological parameters. Operation 206 may be performed by one or more hardware processors configured by machine-readable instructions including a component that is the same as or similar user converting component 110, in accordance with one or more implementations.

An operation 208 may include storing the inferred one or more psychological parameter values to a first psychological profile that characterizes the psychology of the first profiled user. Operation 208 may be performed by one or more hardware processors configured by machine-readable instructions including a component that is the same as or similar to user converting component 110, in accordance with one or more implementations.

An operation 210 may include identifying prospective pieces of content for the users based on one or more psychological parameter value or a psychological profile associated with a profiled user. Operation 210 may be performed by one or more hardware processors configured by machine-readable instructions including a component that is the same as or similar to content identifying component 112, in accordance with one or more implementations.

An operation 212 may include effectuating presentation of the prospective pieces of content to the users within the digital environments. Operation 212 may be performed by one or more hardware processors configured by machine-readable instructions including a component that is the same as or similar to presentation component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to identify psychological profiles of users by utilizing correlations between content classifications and content interaction, the system comprising:
electronic storage that stores i) taxonomical classifications of individual pieces of content, wherein individual taxonomical classifications include content classes and content subclasses to the content classes for the individual pieces of content, wherein the taxonomical classifications conform to a taxonomy that defines a hierarchical system of the content classes and the content subclasses, wherein the individual pieces of content are designated by the corresponding taxonomical classifications as being included in specified ones of the content classes and the content subclasses, ii) psychological profiles for profiled users of digital environments, wherein the psychological profiles include psychological parameter values for psychological parameters that characterize psychology of individual profiled users, iii) content-specific correlations between the psychological parameter values of one or more of the psychological parameters included in the psychological profiles for the profiled users and the individual pieces of content, and (iv) interaction information associated with the profiled users that characterizes interactions of the profiled users with one or more of the pieces of content;
one or more processors configured by machine-readable instructions to:
obtain interaction information, from online platforms that provide the digital environments, for unprofiled users, wherein the interaction information for individual unprofiled users specifies i) instances of interactions between the individual unprofiled users and one or more of the individual pieces of content in the digital environments and ii) timing information for the instances;
convert the unprofiled users to profiled users, wherein converting a first individual ones of the unprofiled users includes:
inferring psychological parameter values of the individual unprofiled user for one or more of the psychological parameters by:
analyzing the interaction information for individual ones of the profiled users and the interaction information for the individual unprofiled users to determine pieces of contents that the profiled users and the unprofiled users interacted with of which have identical or similar ones of the taxonomical classifications, and
determining, based on the determined pieces of content and the psychological parameter values included in the content-specific correlations, the psychological parameter values for the one or more psychological parameters of the individual unprofiled users, and
storing the inferred one or more psychological parameter values to original psychological profiles in the electronic storage so that the unprofiled users are newly profiled users associated with the original psychological profiles that characterizes the psychology of the newly profiled users;
identify prospective pieces of content based on the psychological profiles of the profiled users including the newly profiled users; and
effectuate presentation of the prospective pieces of content for the profiled users, including the newly profiled users, in the digital environments.

2. The system of claim 1, wherein the one or more processors is further configured by machine-readable instructions to:
identify prospective pieces of content for the first profiled user based on the inferred psychological parameter values, and
effectuate presentation of the prospective pieces of content to the first profiled user within the digital environments.

3. The system of claim 2, wherein the presentation of the prospective pieces of content includes presenting a list of the prospective pieces of content within the digital environments.

4. The system of claim 1, wherein the individual pieces of content are characterized by at least a mode of user interaction, an interactivity type, a theme, and one or more subjects.

5. The system of claim 1, wherein the individual pieces of content includes at least a portion of a game, a television show, a movie, a brand, an interest, an activity, a game mechanic, a brand, an art style, an application, an application feature, a theme, and/or a subscription.

6. The system of claim 1, wherein the psychological profiles for profiled users includes answers of the users to questions presented to the profiled users.

7. The system of claim 1, wherein the psychological profiles for profiled users are associated with and/or generated in relation with particular online games, online platforms, and/or online applications.

8. The system of claim 1, wherein the interaction information includes timing information, expense information, and/or movement information related to the interactions with the individual pieces of content.

9. The system of claim 1, wherein the interaction information includes whether the unprofiled users have affinities for the individual pieces of content or aversions to the individual pieces of content.

10. The system of claim 1, wherein the psychological parameter values characterize one or more feeling, emotion, perception, thought, and behavior of profiled users.

11. A method to identify psychological profiles of users by utilizing correlations between content classifications and content interaction, the system comprising:
storing, in electronic storage i) taxonomical classifications of individual pieces of content, wherein individual taxonomical classifications include content classes and content subclasses to the content classes for the individual pieces of content, wherein the taxonomical classifications conform to a taxonomy that defines a hierarchical system of the content classes and the content subclasses, wherein the individual pieces of content are designated by the corresponding taxonomical classifications as being included in specified ones of the content classes and the content subclasses, ii) psychological profiles for profiled users of digital environments, wherein the psychological profiles include psychological parameter values for psychological parameters that characterize psychology of individual profiled users, iii) content-specific correlations between the psychological parameter values of one or more of the psychological parameters included in the psychological profiles for the profiled users and the individual pieces of content, and (iv) interaction information associated with the profiled users that characterizes interactions of the profiled users with one or more of the pieces of content;
obtaining interaction information, from online platforms that provide the digital environments, for unprofiled users, wherein the interaction information for individual unprofiled users specifies i) instances of interactions between the individual unprofiled users and one or more of the individual pieces of content in the digital environments and ii) timing information for the instances;
converting the unprofiled users to profiled users, wherein converting individual ones of the unprofiled users includes:
inferring psychological parameter values of the f individual unprofiled user for one or more of the psychological parameters by:
analyzing the interaction information for individual ones of the profiled users and the interaction information for the individual unprofiled users to determine pieces of contents that the profiled users and the unprofiled users interacted with of which have identical or similar ones of the taxonomical classifications, and
determining, based on the determined pieces of content and the psychological parameter values included in the content-specific correlations, the psychological parameter values for the one or more psychological parameters of the individual unprofiled users, and
storing the inferred one or more psychological parameter values to original psychological profiles in the electronic storage so that the unprofiled users are newly profiled users associated with the original psychological profiles that characterizes the psychology of the newly profiled users;
identifying prospective pieces of content based on the psychological profiles of the profiled users including the newly profiled users; and
effectuating presentation of the prospective pieces of content for the profiled users, including the newly profiled users, in the digital environments.

12. The method of claim 11, further comprising:
identifying prospective pieces of content for the first profiled user based on the inferred psychological parameter values, and
effectuating presentation of the prospective pieces of content to the first profiled user within the digital environments.

13. The method of claim 12, wherein the presentation of the prospective pieces of content includes presenting a list of the prospective pieces of content within the digital environments.

14. The method of claim 11, wherein the individual pieces of content are characterized by at least a mode of user interaction, an interactivity type, a theme, and one or more subjects.

15. The method of claim 11, wherein the individual pieces of content includes at least a portion of a game, a television show, a movie, a brand, an interest, an activity, a game mechanic, a brand, an art style, an application, an application feature, a theme, and/or a subscription.

16. The method of claim 11, wherein the psychological profiles for profiled users includes answers of the users to questions presented to the profiled users.

17. The method of claim 11, wherein the psychological profiles for profiled users are associated with and/or generated in relation with particular online games, online platforms, and/or online applications.

18. The method of claim 11, wherein the interaction information includes timing information, expense information, and/or movement information related to the interactions with the individual pieces of content.

19. The method of claim 11, wherein the interaction information includes whether the unprofiled users have affinities for the individual pieces of content or aversions to the individual pieces of content.

20. The method of claim 11, wherein the psychological parameter values characterize one or more feeling, emotion, perception, thought, and behavior of profiled users.
